(19) United States
(12) Patent Application Publication
(10) Pub. No.: US 2013/0152452 A1
(43) Pub. Date: Jun. 20, 2013

(54) Reusable Insect Trapping Systems and Methods

(71) Applicants: Heider S. Lazzarini, Bellingham, WA (US); Todd B. Abernethy, Skaneateles, NY (US); Mark A. Ferguson, Memphis, NY (US)

(72) Inventors: Heider S. Lazzarini, Bellingham, WA (US); Todd B. Abernethy, Skaneateles, NY (US); Mark A. Ferguson, Memphis, NY (US)

(73) Assignee: UNITED INDUSTRIES CORPORATION, Earth City, MO (US)

(21) Appl. No.: 13/325,516

(22) Filed: Dec. 14, 2011

(51) Int. Cl. A01M 1/14; A01M 1/10

(52) U.S. Cl. 43/114; 43/121

(57) ABSTRACT

A trap system for insects includes a container assembly comprising a vessel having a window region, and trap material. The container assembly defines a container chamber. A stake assembly may be attached to the assembly to secure the assembly to the ground. The trap system may include a disposable liner. The disposable liner defining a liner chamber and is arranged within the container chamber. The trap material is arranged within the container assembly such that insects that enter the assembly are trapped within by the trap material.

### TECHNICAL FIELD

The present invention relates to insect trap systems and methods and, more particularly, to insect traps that allow ingress and prevent egress of flying insects.

### BACKGROUND

Insect traps accumulate dead insects. The cleaning and replenishing of such traps thus can require the handling of dead insects and materials used to attract and capture the insects. The need exists for improved insect traps that facilitate and improve the cleaning and replenishing of insect traps.

### SUMMARY

The present invention may be embodied as a trap system for insects comprising a container, a disposable liner, and trap material. The container defines a container chamber. The disposable liner defining a liner chamber and is arranged within the container chamber. The trap material is arranged within the liner chamber such that insects that enter the liner chamber are trapped within the liner chamber by the trap material.

The present invention may also be embodied as a trap system comprising a container assembly and a disposable liner. The container assembly comprises a vessel comprising a vessel side wall and a vessel end or bottom wall and defining a vessel opening, a cap member adapted to be attached to the vessel side wall at the container opening, and an obstruction member adapted to be supported by the cap member for movement between open and closed positions. The disposable liner comprises a liner side wall and a liner end wall and defines a container opening, where the disposable liner extends through the container opening to line the side wall and container end wall.

The present invention may also be embodied as a method of trapping insects comprising the following steps. A container defining a container chamber is provided. First and second liners each defining a liner chamber are provided. The first liner is arranged within the container chamber. Trap material is arranged within the liner chamber of the first liner such that insects that enter the liner chamber are trapped within the liner chamber by the trap material. The first liner containing insects is removed from the container chamber. The first liner is disposed of. The second liner is arranged within the container chamber. Trap material is arranged within the liner chamber of the second liner such that insects that enter the liner chamber are trapped within the liner chamber by the trap material.

The present invention may also be embodied as a trap system for insects comprising a container assembly defining a container chamber wherein the container assembly comprises a vessel comprising a vessel side wall and a vessel end wall defining a container opening. The vessel side wall includes a window region and a non-window region surrounding the window region with the window region being sufficiently transparent to enable a user to view the contents of the container chamber via the window region. The non-window region is sufficiently opaque so as to impede a user from viewing the contents of the container chamber via the non-window region.

The present invention may also be embodied as a trap system for insects comprising a container assembly defining a container chamber wherein the container assembly comprises a threaded socket. A stake device having a threaded upper portion and a lower portion is adapted to threadably connect to the threaded socket of the assembly via the threaded portion of the stake device. The lower portion of the stake device is shaped and configured for being stuck in the ground.

### DESCRIPTION OF THE DRAWINGS

FIG. 1 is a perspective view of a first example insect trap of the present invention;

FIG. 2 is an exploded view of the first configuration of the first example insect trap;

FIG. 3 is a detail assembly view of the first example insect trap;

FIG. 4 is a detail view of the first example insect trap;

FIG. 5 is a perspective view of a first example cap member of the first example insect trap;

FIG. 6 is a front elevation, section view of the first example cap member;

FIG. 7 is a front elevation, section view of a detail of a first example container assembly of the first example insect trap;

FIG. 8 is a perspective view of a first example obstruction member of the first example insect trap;

FIG. 9 is a front elevation view of the first example obstruction member;

FIG. 10 is a front elevation, partial section view of a detail of the first example container assembly;

FIG. 11 is a front elevation, partial section assembly detail view of a lid assembly of the first example trap system;

FIG. 12 is a front elevation, partial section detail view of the lid assembly of the first example trap system in a closed configuration;

FIG. 13 is a front elevation, partial section detail view of the lid assembly of the first example trap system in an open configuration;

FIG. 14 is an elevation view of a first example stake member of the first example trap system;

FIG. 15 is a front elevation, partial section detail view of a first example stake assembly of the first example trap system;

FIG. 16 is a perspective view of a first example bag member that may be used with the first example trap system in a second configuration;

FIG. 17 is a front elevation, section detail view depicting the first example bag member and a first example vessel of the first example trap system in the second configuration;

FIG. 18 is a front elevation, partial section detail view of the second configuration of the first example trap system in a closed configuration;

FIG. 19 is a perspective view of a second example bag member that may be used with the first example trap system in a third configuration;

FIG. 20 is a front elevation, partial section assembly detail view depicting the second example bag member and the first example vessel of the first example trap system in the third configuration;

FIG. 21 is a front elevation, section view depicting the second example bag member and the first example vessel of the first example trap system in the third configuration;

FIG. 22 is a front elevation, section detail view depicting the second example bag member in a first configuration and the first example vessel of the first example trap system in the third configuration;

FIG. 23 is a front elevation, section detail view depicting the second example bag member in a second configuration and the first example vessel of the first example trap system in the third configuration;

FIG. 24 is a perspective view of a second example trap system of the present invention as installed;

FIG. 25 is an exploded, perspective view of the second example trap system;

FIG. 26 is a rear perspective view of the second example trap system; and

FIG. 27 is a side elevation, section view of the second example trap system as installed.

### DETAILED DESCRIPTION

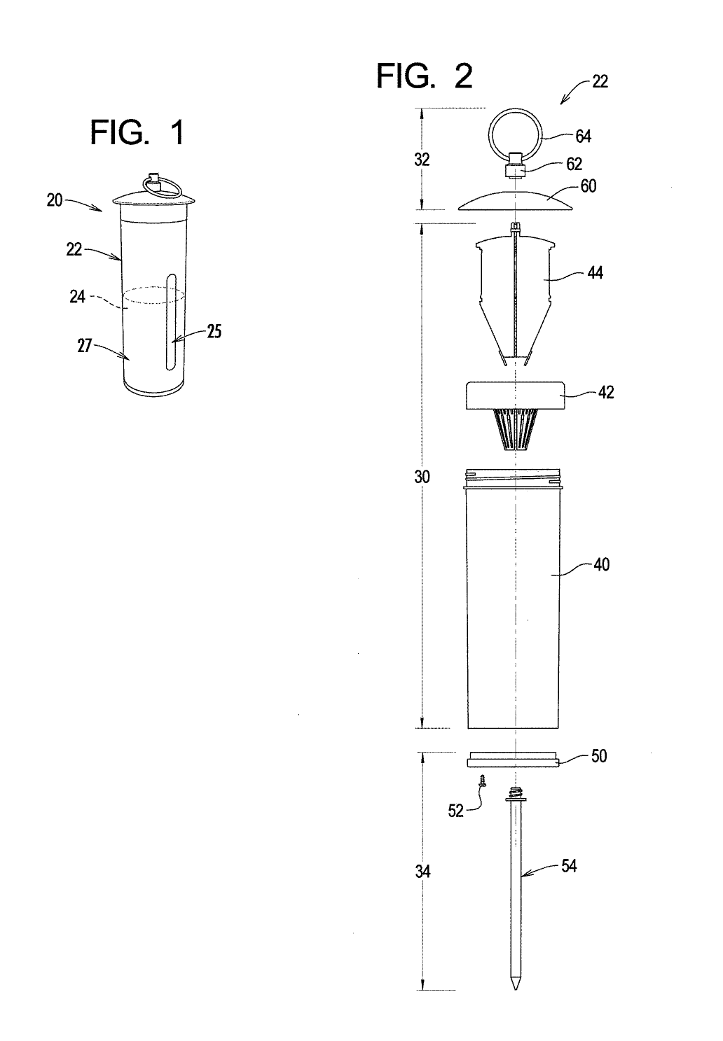

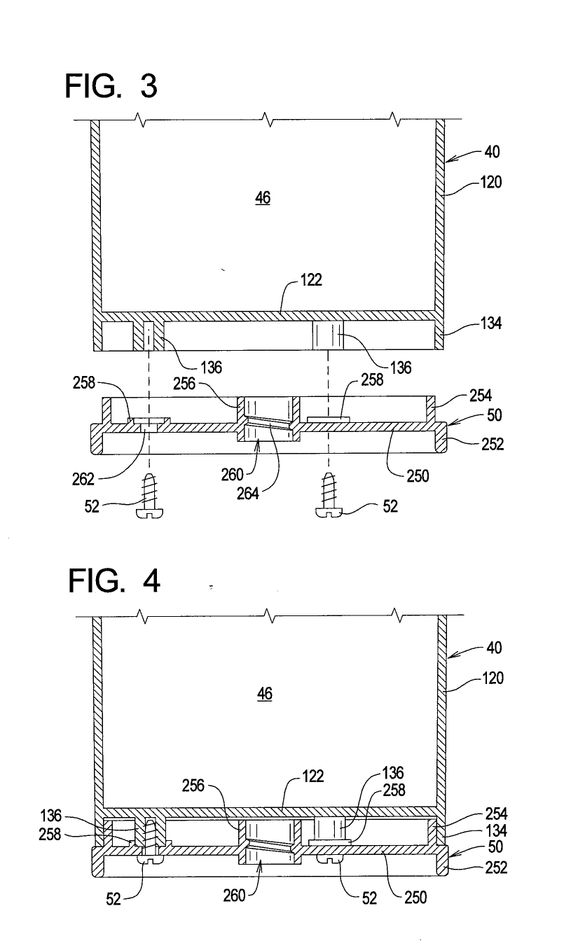

Referring initially to FIG. 1 of the drawing, depicted therein is a first example trap system 20 constructed in accordance with, and embodying, the principles of the present invention. The example trap system 20 comprises a container assembly 22. The trap system may further include a fluid 24. The container assembly 22 comprises a vessel 40 (FIGS. 2, 3, and 4) comprising a vessel side wall 120 (FIGS. 3 and 4).

The vessel side wall 120 includes a window region 25 and a non-window region 27 surrounding the window region 25. The window region 25 is sufficiently transparent so that a user may view through the window region 25 to view and monitor the contents of the container chamber 46. This allows a user to check to see whether and how many insects have been trapped within the container chamber 46 without opening the trap. The non-window region 27 is sufficiently opaque so as to impede a user or other viewers from viewing the contents of the container chamber 46 through the non-window region 27. In certain embodiments, the non-window region 27 comprises at least about 50%, or at least about 60%, or at least about 70%, or at least about 80%, or at least about 90% of the surface area of the vessel side wall 120. In certain embodiments, the window region 25 comprises at least about 5%, or at least about 10%, or at least about 20%, or at least about 30%, or at least about 40%, or at least about 50% of the surface area of the vessel side wall 120. In certain embodiments, the vessel side wall 120 comprises multiple window regions 25 such that the total surface area of the window regions 25 combined and the surrounding non-window region 27 is consistent with the above. Thus, generally, a viewer will not be able to view into the container chamber 46 to see its contents which may be considered unsightly, unless they position themselves to view into the container chamber 46 via the window region 25.

FIG. 2 illustrates that the trap assembly 20 comprises a container assembly 30, a lid assembly 32, and a stake assembly 34. The example container assembly 30 comprises a vessel 40, a cap member 42, and an obstruction member 44 and defines a container chamber 46. The example stake assembly 34 comprises a bottom plate 50, one or more screws 52, and a stake member 54. The example lid assembly 32 comprises a cover plate 60, a cover retainer 62, and a ring 64.

As shown in FIGS. 1, 3, 4, and 10-13, the example vessel 40 comprises a vessel side wall 120 and a vessel bottom wall 122. The example side wall 120 is cylindrical and defines a circular rim 124, and the example rim 124 in turn defines a vessel opening 126. The example upper flange 132 is an annular ring extending around the sidewall 120 and is substantially parallel to the rim 124. A vessel threaded portion 130 is formed on the vessel side wall 120 adjacent to the rim 124 and between the rim 124 and an upper flange 132. A lower flange 134 extends from the bottom wall 122. The example lower flange 134 is a cylinder having substantially the same diameter as the vessel side wall 120. The example vessel bottom wall 122 is circumscribed by the lower flange 134, and one or more screw cylinders 136 extend from the vessel bottom wall within the lower flange 134.

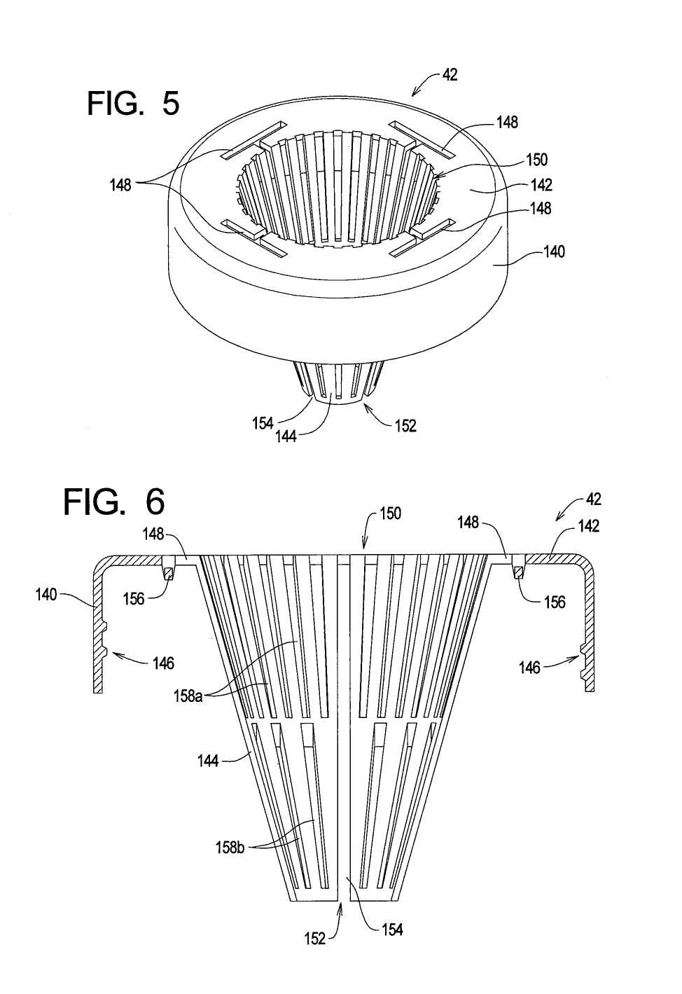

Referring now to FIGS. 5 and 6 of the drawing, the example cap member 42 will be described in further detail. The example cap member 42 defines a cap side wall 140, a cap plate 142, and a basket portion 144. The example cap side wall 140 is cylindrical, and a cap threaded portion 146 is formed on an inner surface of the cap side wall 140. The cap side wall 140 and vessel side wall 120 are sized and dimensioned such that the cap threaded portion 146 engages the vessel threaded portion 130 to allow the cap member 42 to be detachably attached to the vessel 40. Plate slots 148 are formed in the cap plate 142, and upper and lower basket openings 150 and 152 are formed in the basket portion 144. One or more basket slots 154 are formed in the example basket portion 144. A support portion 156 of the cap plate 142 is arranged adjacent to each of the cap plate slots 148. Additionally, upper and lower basket perforations 158a and 158b are formed in the basket portion 144.

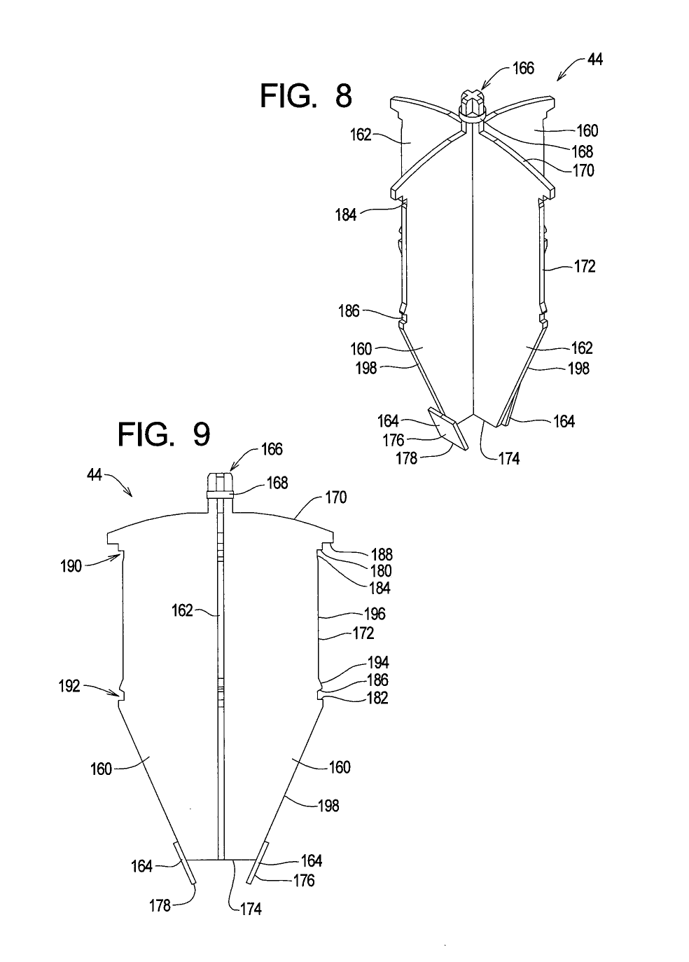

Referring now to FIGS. 8 and 9 of the drawing, the example obstruction member 44 will now be described in further detail. The example obstruction member 44 comprises one or more fins, and, in this example, comprises one or more primary fins 160 and one or more secondary fins 162. A fin plate 164 is attached to each of the primary fins 160. A mounting portion 166 extends from one end of the example obstruction member 44, and a mounting flange 168 extends around the example mounting portion 166.

The example primary and secondary fins 160 and 162 are substantially, but not necessarily, the same. Elements of the fins 160 and 162 (and fin plate(s) 164) will thus be discussed together herein in the interests of brevity. The fins 160/162 each define an upper edge 170, a side edge 172, and a lower edge 174. The fin plate(s) 164 each define an engaging surface 176 and a lower edge 178. The upper edge 170 is flat or shaped as necessary to accommodate the cover plate 60 as will be described in further detail below. The side edge(s) 172 each define an upper support surface 180 and a lower support surface 182.

An upper lock surface 184 is arranged adjacent to the upper support surface 180, and a lower lock surface 186 is arranged adjacent to the lower support surface 182. A plate surface(s) 188 is formed on the example side edge(s) 172. The upper support surface 180 and upper lock surface 184 define an upper notch 190, while the lower support surface 182 and lower lock surface 186 define a lower notch 192. A cam surface 194 is formed adjacent to the lower lock surface 186, and a guide surface 196 is formed between the upper lock surface 184 and the cam surface 194. An angle surface 198 extends from the lower notch 192 to the lower edge 174. The example fin plate(s) 164 are attached to the angle surface 198 such that the lower edge(s) 178 of the fin plate(s) 164 extend beyond the lower edge 174 of the fins 160/162 in the example obstruction member 44.

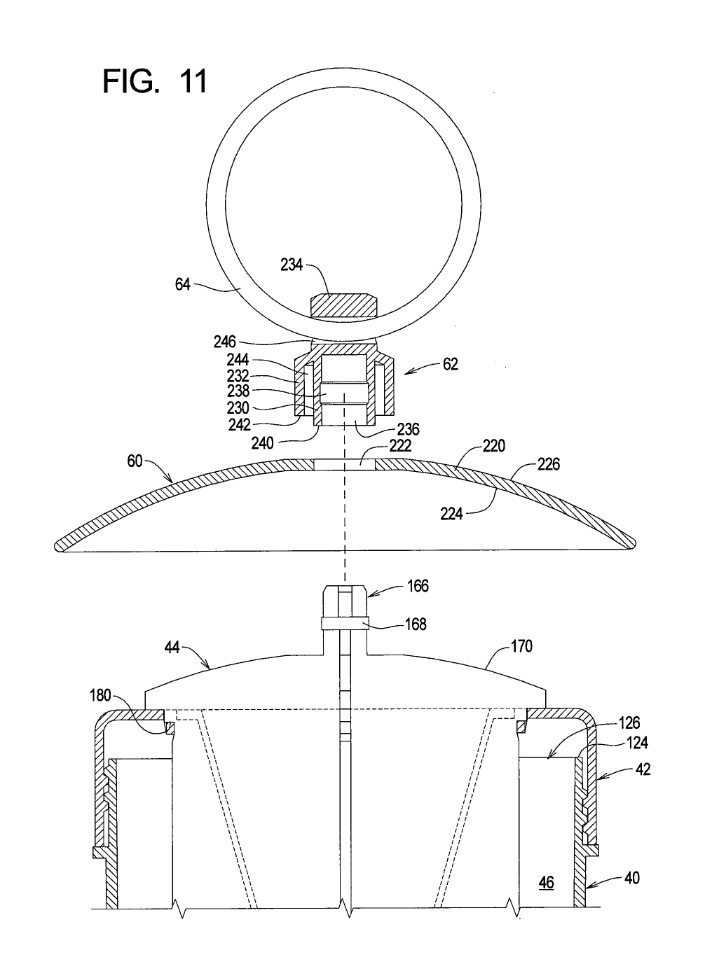

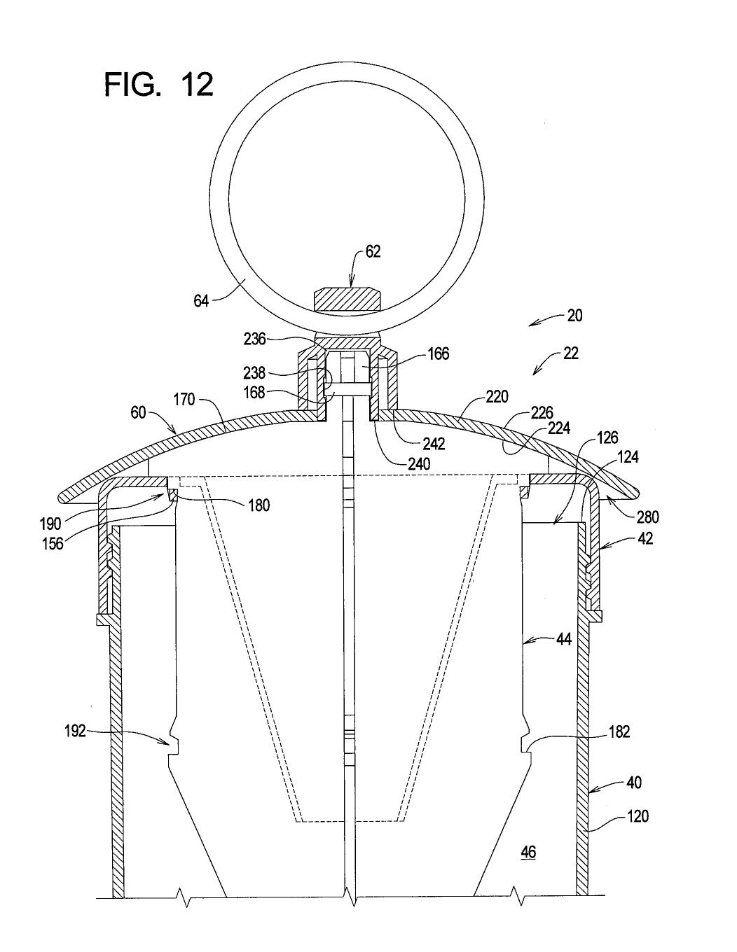

Referring now to FIGS. 11 and 12 of the drawing, the example lid assembly 32 will now be described in further detail. The example cover plate 60 comprises a cover wall 220 and defines a cover opening 222. The cover wall 220 defines a inner surface 224 and an outer surface 226. The example cover wall 220 is curved, and the inner surface 224 is concave and the outer surface 226 is convex. The example upper edge 170 of the fins 160/162 is thus curved to accommodate the concave inner surface 224 without a gap as best depicted in FIG. 12.

The example cover retainer 62 comprises an inner wall 230 and an outer wall 232 extending from a ring portion 234. The inner wall 230 defines a retainer cavity 236, and a mounting notch 238 is formed in the inner wall 230 within the retainer cavity 236. The inner wall 230 defines an inner wall edge 240, and the outer wall 232 defines an outer wall edge 242. The example inner wall 230 and outer wall 232 are cylindrical, and an annular chamber 244 is formed between them in the example cover retainer 62. A ring opening 246 is formed in the ring portion 234.

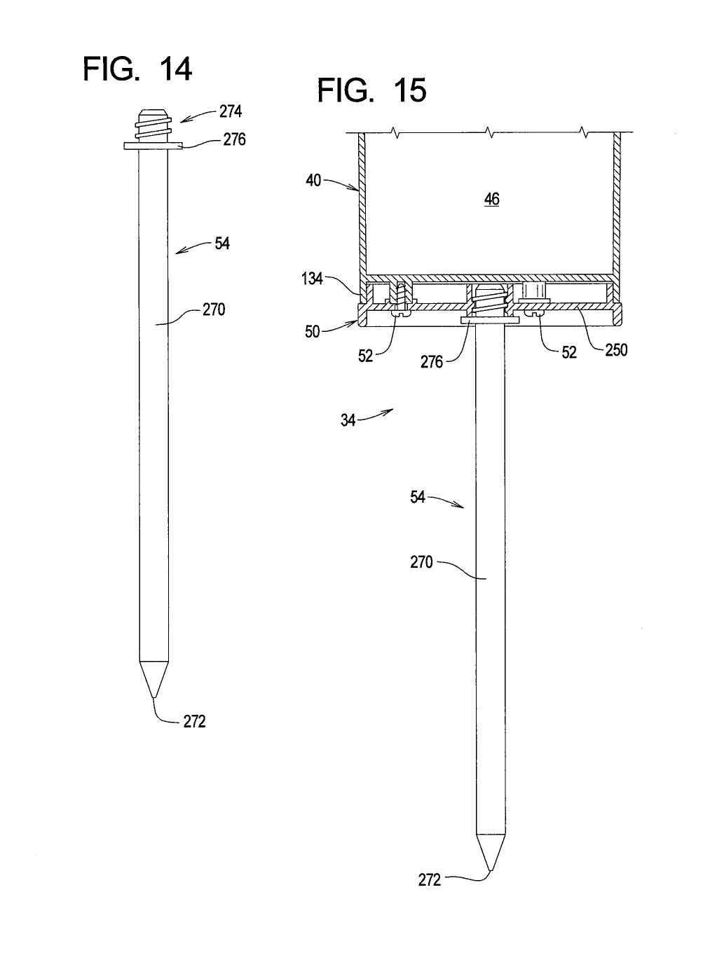

The container assembly 22 may be adapted to be anchored to the ground. In such an example, the container assembly 22 comprises a threaded socket 264 (FIG. 3). A stake device or member 54 (FIG. 2) has a threaded upper portion 274 and a lower portion 270 (FIG. 14), the threaded upper portion 274 being adapted to threadably connect to the threaded socket 264 of the container assembly (FIG. 15). The lower portion 270 of the stake device is shaped and configured for being stuck into the ground 272.

Referring now for a moment to FIGS. 3, 4, 14, and 15 of the drawing, an example stake assembly 34 will now be described in further detail. As perhaps best shown in FIG. 3, the example bottom plate 50 of the stake assembly 34 comprises a plate main wall 250, a plate lower flange 252, and a plate upper flange 254. A stake cylinder 256 is formed in the plate main wall 250. One or more locator walls 258 extends from the main wall 250 within the plate upper flange 252. A stake opening 260 extends through the stake cylinder 256. A screw opening 262 is associated with each of the locator walls 258. A plate threaded portion 264 is formed on the stake cylinder 256 within the stake opening 260. FIG. 14 best shows that the example stake member 54 comprises a stake shaft 270 defining a stake point 272 on one end and a stake threaded portion 274 on the other end. A stake flange 276 is formed on the stake shaft 270 adjacent to the stake threaded portion 274.

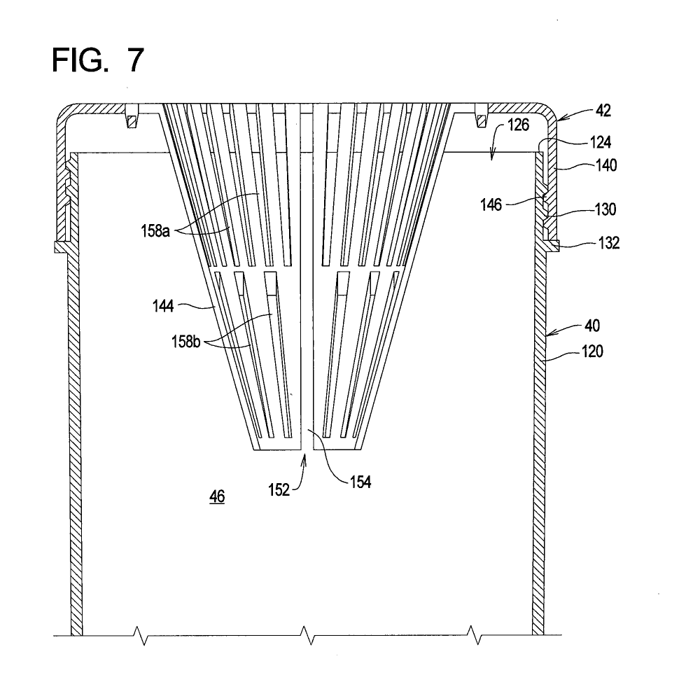

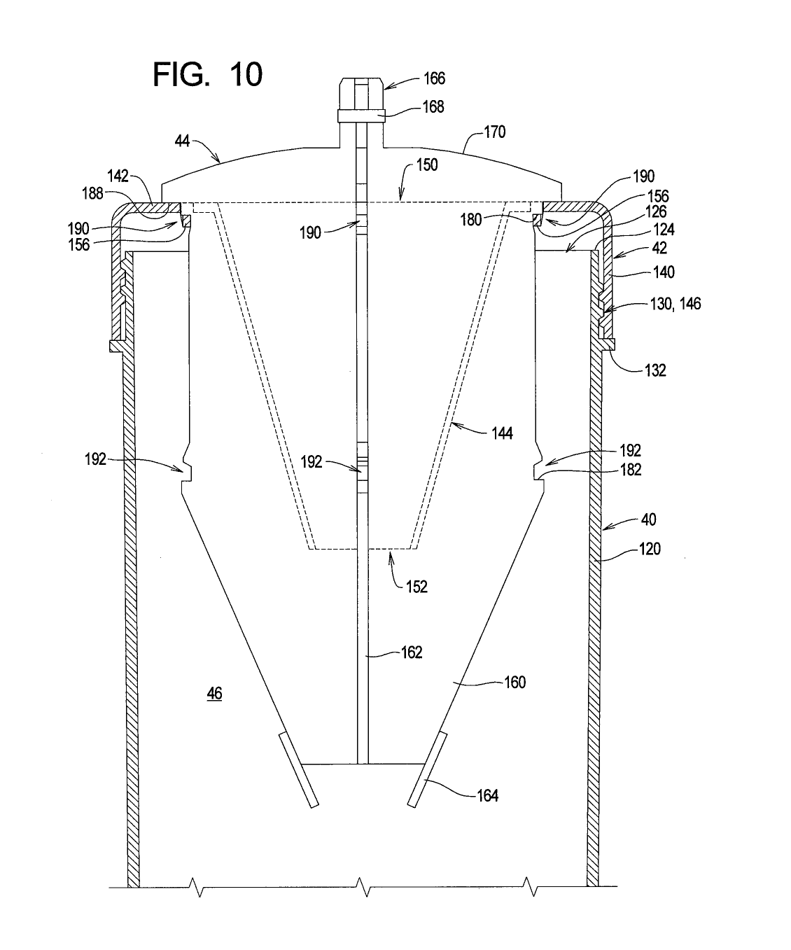

The trap assembly 22 is formed and used generally as follows. Initially, the cap member 42 is secured onto the vessel 40 by engaging the vessel threaded portion 130 with the cap threaded portion 146 and rotating the cap member 42 relative to the vessel 40 to obtain a first trap subassembly as depicted in FIG. 7. The obstruction member 44 is then displaced such that the fin plate(s) 164 enters the basket upper opening 150 with the fins 160/162 aligned with the basket slots 154. Continued displacement of the obstruction member 44 causes the fin plate(s) 164 to deform the basket portion 144 to allow the plate(s) 164 to pass through the lower basket opening 152 to form a second trap subassembly as shown in FIG. 10. At this point, the plate(s) 164 prevent inadvertent removal of the obstruction member 44 from the first trap subassembly.

As perhaps best shown in FIG. 11, the mounting portion 166 of the obstruction member 44 is then passed through the cover opening 222 in the cover plate 60. The cover retainer 62 is then displaced such that the mounting portion 166 enters the retainer cavity 236. The cover retainer 62 is then further displaced until the outer wall edge 242 engages the outer surface 226 of the cover plate 60. At this point, the mounting flange 168 enters the mounting notch 238 to prevent inadvertent removal of the cover retainer 62 from the obstruction member 44, the cover retainer 62 holds the cover plate 60 against the upper edge 170 of the fins 160/162, the inner wall edge 240 engages the upper edge 170, and the inner wall 230 passes through the cover opening 222, and a third trap subassembly is formed as shown in FIG. 12.

After the third trap subassembly has been formed, the user may decide how to proceed based on the intended use of the trap system 20. The trap system may comprise a hanging connector secured to the upper portion of the container assembly. The hanging connect is configured to enable a user to operatively connect the hanging connector to an elevated object, such as a post or a limb of a tree, thereby suspending the trap system from the elevated object. The hanging connector may be any of numerous known hanging devices such as a ring, hook, clip, loop, line, etc. In certain embodiments, the hanging connector comprises a ring. For example, if the user intends to hang the trap system 20, the user may use a ring 64 inserted through the ring opening 246, and construction of the trap assembly 22 is complete. The user may connect the ring 64 to a hook or other structural member to hang the trap system 20 in a generally upright first use configuration.

If, however, the user intends to mount the trap system 20 on the ground, the user will typically not attach the ring 64 to the cover retainer 62. Instead, the user may arrange the bottom plate 50 such that the upper flange 254 thereof lies within the vessel lower flange 134 and the locator walls 258 engage the screw cylinders 136. The screws 52 are then inserted through the screw openings 262 and rotated such that the screws 52 engage the screw cylinders 136. The screws 52 thus detachably attach the bottom plate 50 to the vessel 40 as shown in FIG. 4. The stake threaded portion 274 is then engaged with the plate threaded portion 264 and the stake member 54 rotated relative to the bottom plate 50 to detachably attach the stake member 54 to the third trap subassembly. The stake point 272 may then be driven into the ground, or the stake member 54 otherwise securely held, to support the vessel 40 in a generally upright second use configuration.

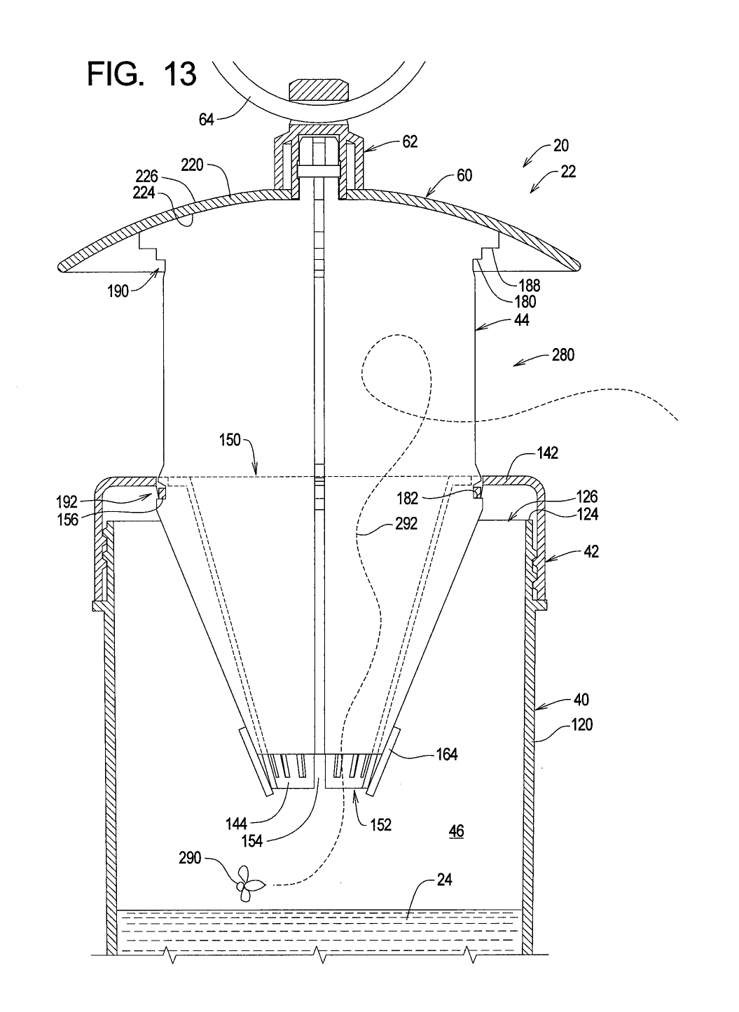

Referring now to FIGS. 12 and 13, it can be seen that the obstruction member 44 is movable between a closed configuration (FIG. 12) and an open configuration (FIG. 13) relative to the vessel 40.

In the closed configuration, the upper support notch(es) 190 receives the support(s) 156 such that the upper lock surfaces 184 inhibit relative movement between the obstruction member 44 and the vessel 40. In this closed configuration, a gap 280 formed between the inner surface 224 of the cover plate 60 and the cap plate 142 is negligible, and insects cannot enter the vessel chamber 46. Deliberate application of manual force on the obstruction member 44 away from the vessel 40 allows the support(s) 154 to be removed from the upper support notch(es) 190. Further displacement of the obstruction member 44 away from the vessel causes the support(s) 156 to enter the lower notches 192 (over the cam surface 194) such that the support(s) 156 engage the lower lock surface(s) 186, thereby holding the obstruction member 44 in the open configuration. In this open configuration, the dimensions of the gap 280 are such that insects may enter the vessel chamber 46 through the upper basket opening 150 and the lower basket opening 152.

The example trap system 20 is used as follows. Initially, the cap member 42, obstruction member 44, and lid assembly 32 are removed from the vessel 40. The fluid 24 is typically but not necessarily formulated to attract one or more types of insects. If the fluid 24 is formulated to attract, the fluid 24 may be referred to as lure fluid. The cap member 42, obstruction member 44, and/or cover plate 60 may be colored to provide additional attraction to the appropriate type of insect.

The fluid 24 is then introduced into the vessel chamber 46, and the cap member 42, obstruction member 44, and lid assembly 32 are replaced. The obstruction member 44 is then placed into the open configuration. Any volatiles such as scents or other stimuli released by the fluid 24 are free to flow out of the vessel chamber 46 through the basket slots 154 and the basket perforations 158a and 158b. Insects such as an insect 290 depicted in FIG. 13 may also enter the chamber along an insect path 292 extending through the gap 280, the upper basket opening 150, and the lower basket opening 152. Once inside the chamber 46, the insect 290 has difficulty exiting the chamber 46 through the relatively small lower basket opening 152 and will typically eventually drown in the fluid 24.

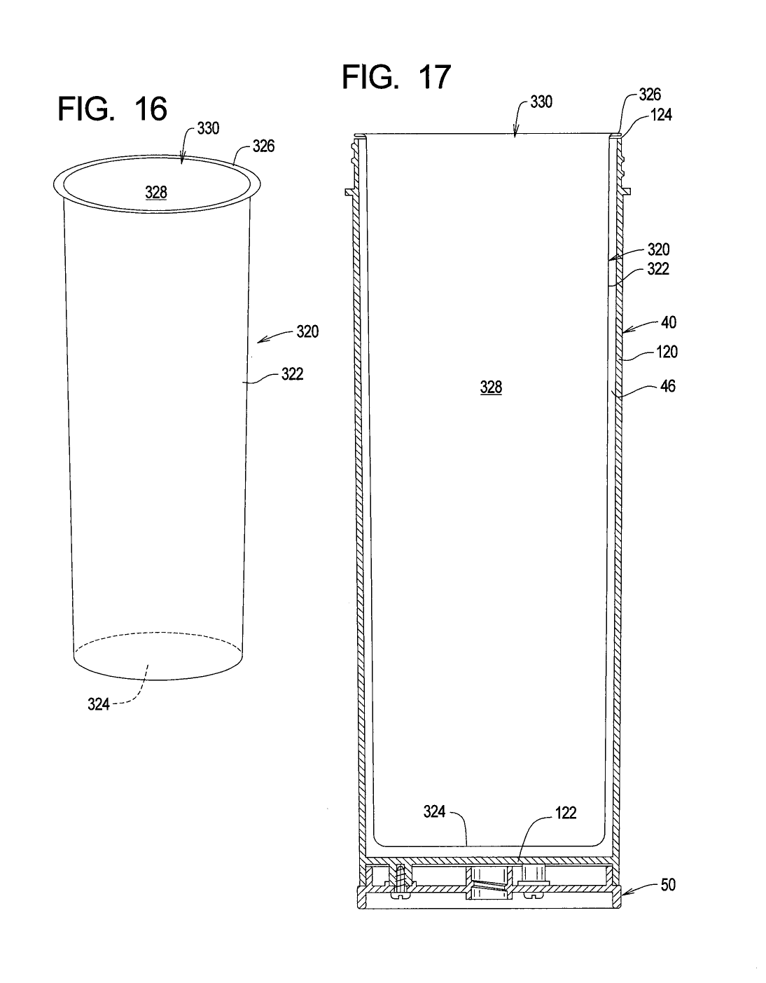

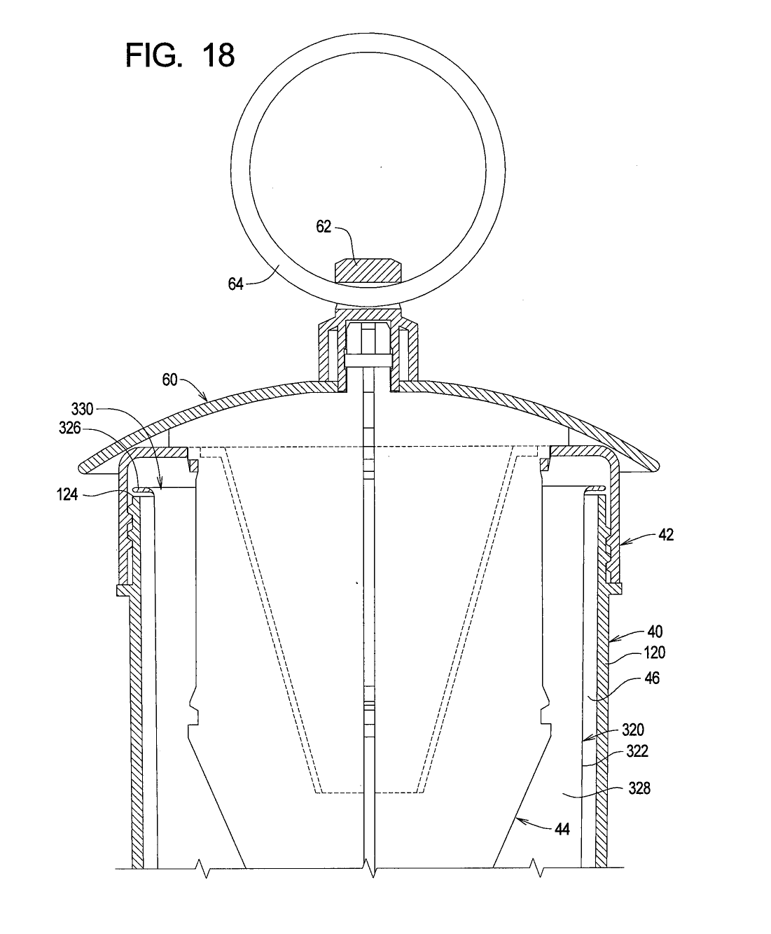

FIGS. 16 and 17 illustrate an alternative embodiment of the trap system 20 further comprising a first example bag member 320. The first example bag member 320 defines a bag side wall 322, a bag bottom wall 324, and a bag flange 326. The bag member 320 defines a bag chamber 328 and a bag opening 330. The example bag flange 326 extends around the bag opening 330. The example bag member 320 is made of a flexible material molded to hold a generally cylindrically or slightly frusto-conical shape. A plurality of bag members 320 may be nested by using a slightly frusto-conical shape.

As shown in FIG. 17, the bag member 320 is sized and dimensioned to occupy substantially the entire vessel chamber 46 with the flange 326 supported by the rim 124 of the vessel 40. The bag member 320 contains the fluid 24 and holds any dead insects to facilitate removal thereof. The optional bag member 320 thus forms a disposable liner to help maintain cleanliness of the trap system 20. A separate twist tie (not shown) may be used to close the opening 330 after the bag member 320 has been removed to prevent accidental spillage of the contaminated fluid 24 and/or any insects therein.

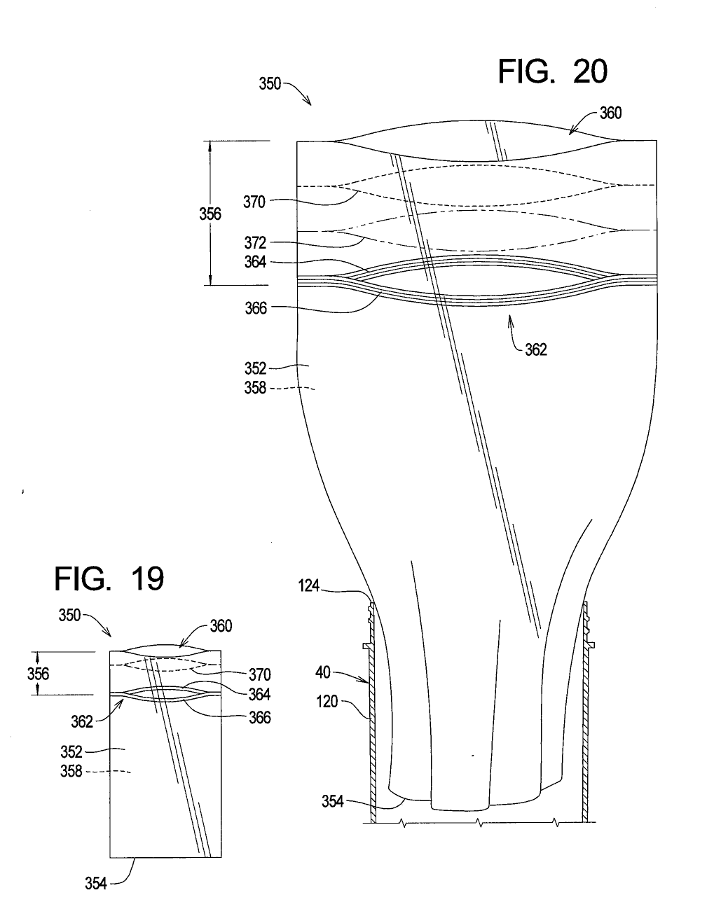

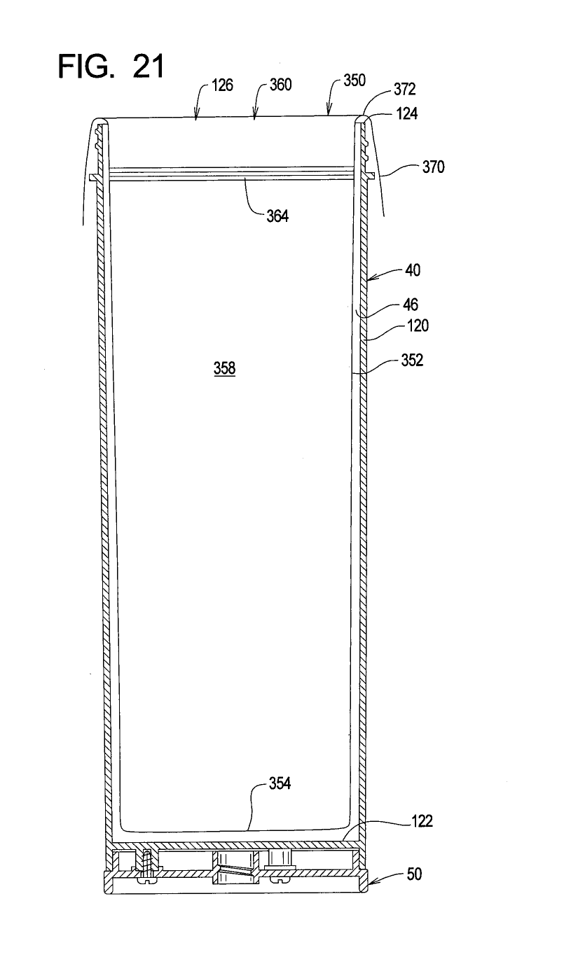

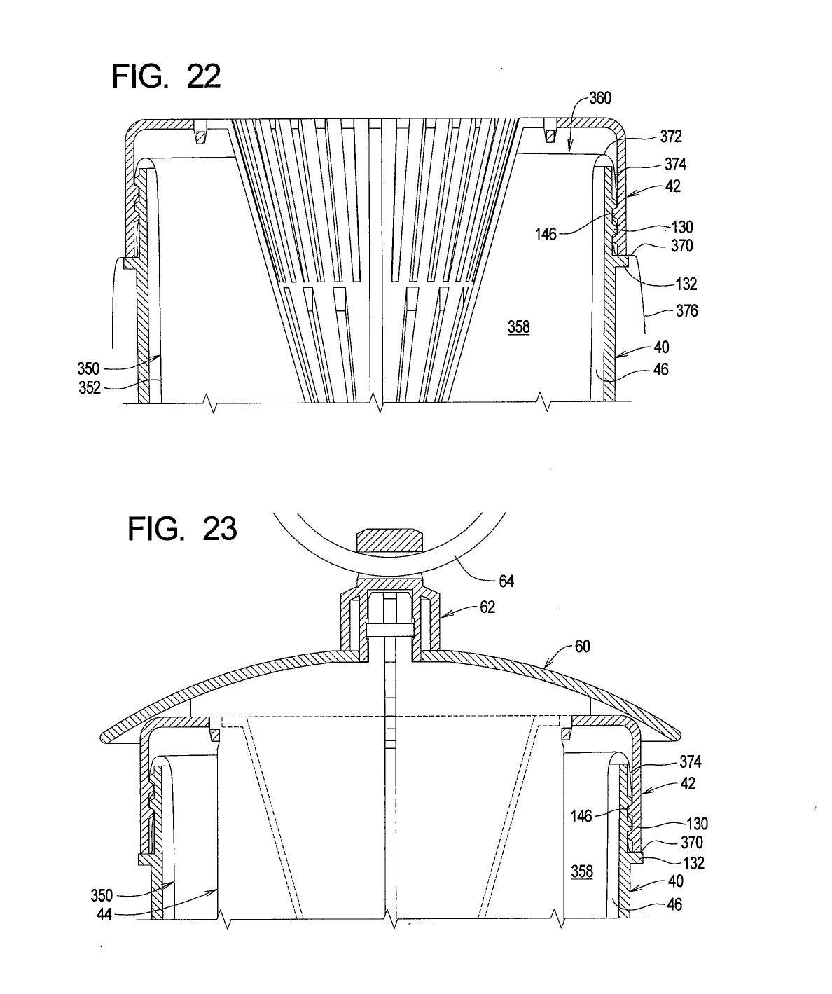

A second example bag member 350 is depicted in FIG. 19-23. The second example bag member 350 may also be used to form a disposable liner for the example trap system 20 described above. The second example bag member 350 comprises a bag side wall 352, a bag bottom wall 354, and a bag flange portion 356. The bag member 350 defines a bag chamber 358 that is accessed through a bag opening 360. The flange portion 356 extends around the bag opening 360, and a locking system 362 comprising first and second portions 364 and 366 is formed at an end of the bag opening 360 distal from the opening 360. The first and second portions 364 and 366 of the example locking system 362 engage each other to form what is commonly referred to as a plastic zipper style enclosure, but any other method of closing the opening 360 may be used in place of the example locking system 362. A first reference line 370 is arranged within the flange portion 356 adjacent to the opening 360, and a second reference line 372 is arranged within the flange portion 356 between the first reference line 370 and the locking system 362.

In use, the bag bottom wall 354 is inserted into the vessel chamber 46 until the bottom wall 354 is adjacent to the vessel bottom wall 122. At that point, the flange portion 356 is arranged such that the second reference line 372 is adjacent to the vessel rim 124 and the flange portion 356 is folded such that the first reference line is adjacent to the vessel upper flange 132. With the flange portion 356 so arranged, the optional locking system 362 is located within the vessel chamber 46 adjacent to the vessel opening 126. The cap member 42 is then engaged to the vessel member 40 as generally described above with a captured portion 374 of the flange portion 356 arranged between the vessel threaded portion 130 and the cap threaded portion 146. A waste portion 376 is removed at the first reference line 370. The first reference line 370 may be scored to facilitate removal.

The fluid 24 is arranged within the bag chamber 358, and the trap system 20 is used as described above. When the fluid 24 is spent (e.g., attractant no longer effective or filled with insects), the cap member 42 is removed from the vessel member 40 and the bag member 350 is removed from the vessel chamber 46. The optional locking system 362 may be operated to close the opening 360 and prevent spillage of the contaminated fluid 24 and/or any insects therein. A separate twist tie (not shown) may be used to close the opening 360.

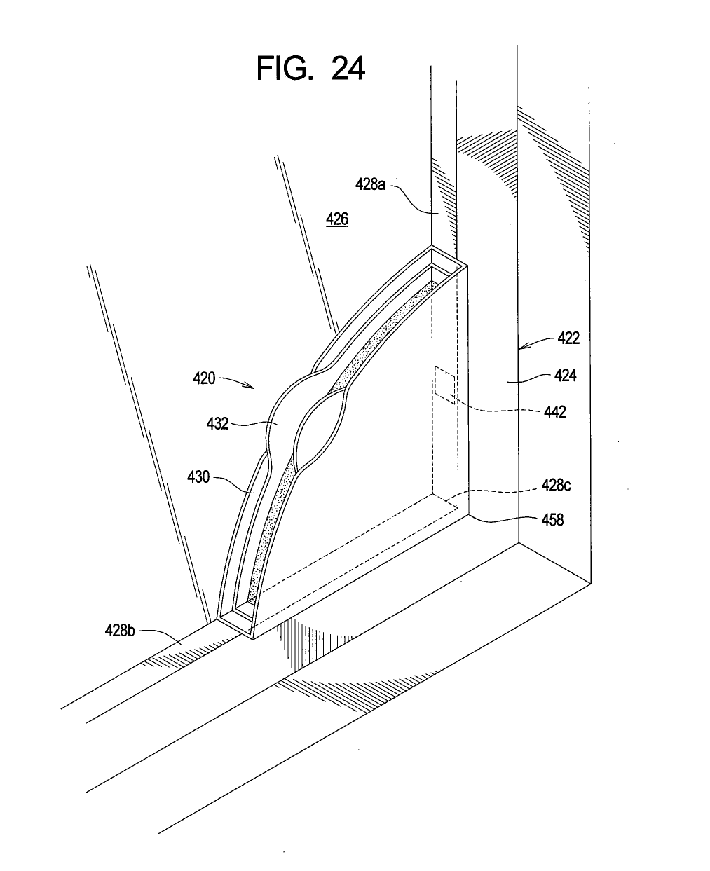

Referring now to FIGS. 24-27 of the drawing, depicted at 420 therein is a second example trap system of the present invention. The second example trap system 420 is adapted to be supported by a window assembly 422 having a frame assembly 424 and a window pane 426. The frame assembly 424 defines a frame surface 428 having a first portion 428a and a second portion 428b. As is conventional, the first and second surface portions 428a and 428b intersect at a corner 428c of the window assembly 422.

The example trap system 420 comprises a trap container assembly 430 and a trap liner 432. As perhaps best shown in FIG. 26, the example trap container assembly 430 comprises a container 440, an adhesive sheet 442, and a release sheet 444. The container 440 defines a first edge wall 450, a second edge wall 452, a first side wall 454, and a second side wall 456. The first and second edge walls 450 and 452 define a trap corner edge 458. The first side wall 454 defines a first wall edge 460, and the second side wall 456 defines a second wall edge 462. First and second notches 464 and 466 are formed in the example first and second wall edges 460 and 462, respectively. The trap container 440 defines a trap chamber 468.

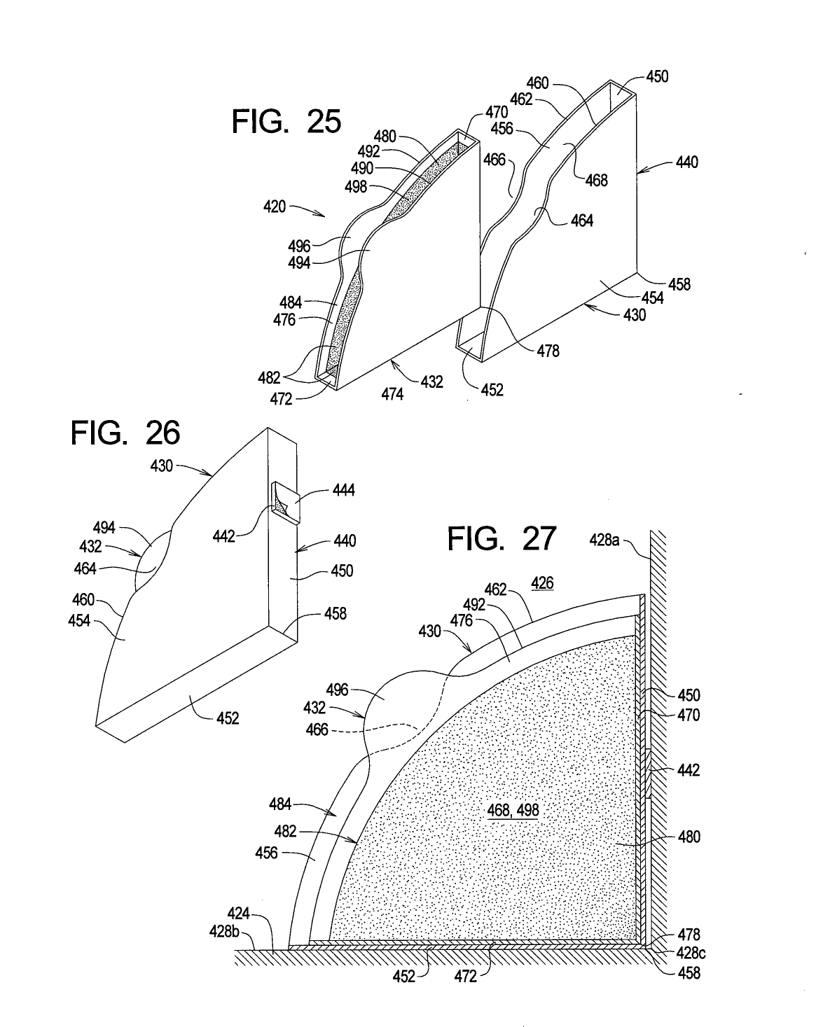

As perhaps best shown in FIGS. 25 and 26, the example trap liner 432 comprises a first inner wall 470, a second inner wall 472, a first side wall 474, and a second side wall 476. The first and second inner walls 470 and 472 define a liner corner edge 478. An adhesive coating 480 is formed on a coated portion 482 of inner surfaces of the walls 470-476. A perimeter portion 484 of the inner surfaces of the walls 470-476 is uncoated with the adhesive coating 480. The first and second side walls 474 and 476 define first and second liner wall edges 490 and 492. First and second tabs 494 and 496 extend from the wall edges 490 and 492. The tabs 494 and 496 form part of the uncoated perimeter portion 484. The trap liner 432 defines a liner chamber 498.

In use, the trap container 440 is attached to the frame surface 428. In particular, the example adhesive sheet 442 is a double stick tape one surface of which is attached to the first edge wall 450 and the other surface of which is initially covered by the release sheet 444. Removing the release sheet 444 exposes one adhesive surface of the adhesive sheet 442, and the trap container 440 is displaced with the second edge wall 452 supported by the second frame surface portion 428b until the exposed adhesive surface of the adhesive sheet 442 engages the first frame portion 428a. At this point, the trap container 440 is secured to the frame surface 428 with the trap corner edge 458 adjacent to the window corner 428c.

Before or after the trap container 440 is attached to the frame surface 428, the trap liner 432 is inserted into the trap container 440. In particular, the uncoated tabs 494 and 496 of the trap liner 432 are pinched together. The material from which the trap liner 432 is made should be light and inexpensive and is disposable but should have sufficient structural integrity to prevent the adhesive coating 480 on the opposing inner surfaces of the first and second side walls 474 and 476 from coming into contact with each other. The liner corner edge 478 is then displaced into the trap chamber 468 until the liner corner edge 478 is adjacent to the trap corner edge 458. The notches 464 and 466 and tabs 494 and 496 facilitate the full insertion of the trap liner 432 into the trap chamber 468 as perhaps best shown in FIG. 27.

Insects that fly into the liner chamber 498 and are trapped when they come into contact with the adhesive coating 480. The adhesive coating 480 may optionally be scented or colored to form an attractant to encourage the insects to enter the liner chamber 498. When the liner chamber 498 is sufficiently full of insects, the tabs 494 and 496 may be grasped to remove the trap liner 432 from the trap chamber 468. The adhesive coating 480 may be pressed together within to seal the liner chamber 498. A new trap liner 432 may then be inserted into the trap chamber 468.

The outer surfaces of the walls 470-476 may be made of, coated by, or covered by a release material or sheet that does not stick to the adhesive coating 480. This allows the liners 432 to be nested one within the other for more compact shipping and storage. The side walls 474 and 476 may be angled slightly towards each other from the wall edges 490 and 492 towards the liner corner edge 478 to facilitate this nesting.

What is claimed is:

1. A trap system for insects comprising:
a container defining a container chamber;
a disposable liner defining a liner chamber, where the liner is arranged within the container chamber; and
trap material arranged within the liner chamber such that insects that enter the liner chamber are trapped within the liner chamber by the trap material.

2. A trap system as recited in claim 1, in which the trap material comprises an attractant.

3. A trap system as recited in claim 1, in which the trap material is a fluid contained by the disposable liner.

4. A trap system as recited in claim 1, in which the trap material is a coating on the disposable liner.

5. A trap system as recited in claim 1, in which the disposable liner is preformed in a shape that complements walls of the container defining the container chamber.

6. A trap system as recited in claim 1, in which:
the disposable liner defines a liner opening; and
the disposable liner comprises a locking system for closing the liner opening.

7. A trap system as recited in claim 1, in which:
the container comprises first and second container side walls and first and second container edge walls and defines a container corner edge;
the disposable liner comprising first and second liner side walls and first and second liner edge walls and defines a liner corner edge.

8. A trap system as recited in claim 7, further comprising an adhesive sheet for attaching the container to a mounting surface.

9. A trap system as recited in claim 1, in which:
the container is an assembly comprising
a vessel with a vessel side wall, a vessel end wall, and defining a container opening,
a cap member adapted to be attached to the container side wall at the container opening, and
an obstruction member adapted to be supported by the cap member for movement between open and closed positions; and
the disposable liner comprises a liner side wall, a liner end wall, and defining a container opening, where the disposable liner extends through the container opening to line the vessel side wall and vessel end wall.

10. A trap system comprising:
the container assembly comprising
a container comprising a container side wall and a container end wall and defining a container opening,
a cap member adapted to be attached to the container side wall at the container opening, and
an obstruction member adapted to be supported by the cap member for movement between open and closed positions; and
the disposable liner comprises a liner side wall and a liner end wall and
defines a container opening, where the disposable liner extends through the container opening to line the side wall and container end wall.

11. A trap system as recited in claim 10, in which:
the cap member comprises a basket portion defining at least one slot;
the obstruction member comprises at least one fin; and
the slot receives the fin to guide the obstruction member between the open and closed configurations.

12. A trap system as recited in claim 11, in which the at least one fin defines first and second surfaces that engage the cap member to fix the obstruction member in the open and closed configurations, respectively.

13. A trap system as recited in claim 11, in which the at least one fin defines first and second support notches that engage the cap member to fix the obstruction member in the open and closed configurations, respectively.

14. A trap system as recited in claim 10, in which the container assembly further comprises a cover plate that is fixed relative to the obstruction member.

15. A trap system as recited in claim 14, in which the container assembly further comprises a retainer for engaging the obstruction member to fix the cover plate relative to the cover member.

16. A trap system as recited in claim 9, further comprising a stake member detachably attached to the vessel.

17. A trap system as recited in claim 16, further comprising a bottom plate attached to the vessel, where the stake member is threaded onto the bottom plate to detachably attach the stake member to the vessel.

18. A method of trapping insects comprising the steps of:
providing a container defining a container chamber;
providing first and second liners each defining a liner chamber;
arranging the first liner within the container chamber;
arranging trap material within the liner chamber of the first liner such that insects that enter the liner chamber are trapped within the liner chamber by the trap material;
removing the first liner containing insects from the container chamber;
disposing of the first liner;
arranging the second liner within the container chamber;
arranging trap material within the liner chamber of the second liner such that insects that enter the liner chamber are trapped within the liner chamber by the trap material.

19. A trap system as recited in claim 1, in which the trap material is a fluid contained by the disposable liner.

20. A trap system as recited in claim 1, in which the trap material is a coating on the disposable liner.

21. A trap system for insects comprising a container assembly defining a container chamber, wherein the container assembly comprises:
a vessel comprising a vessel side wall and a vessel end wall defining a container opening, the vessel side wall including a window region and a non-window region surrounding the window region, the window region being sufficiently transparent to enable a user to view the contents of the container chamber via the window region, the non-window region being sufficiently opaque so as to impede a user from viewing the contents of the container chamber via the non-window region;
a cap member adapted to cover the container opening;
an obstruction member adapted to be supported by the cap member for movement between open and closed positions.

22. A trap system as recited in claim 21 wherein the non-window region comprises at least 60% of the surface area of the vessel side wall.

23. A trap system as recited in claim 22 wherein the window region comprises at least 5% of the surface area of the vessel side wall.

24. A trap system as recited in claim 23, further comprising a trap material within the container chamber, wherein the trap material comprises an attractant.

25. A trap system as recited in claim 21, in which:
the cap member comprises a basket portion defining at least one slot;
the obstruction member comprises at least one fin; and
the slot receives the fin to guide the obstruction member between the open and closed configurations.

26. A trap system as recited in claim 25, in which the at least one fin defines first and second surfaces that engage the cap member to fix the obstruction member in the open and closed configurations, respectively.

27. A trap system as recited in claim 25, in which the at least one fin defines first and second support notches that engage the cap member to fix the obstruction member in the open and closed configurations, respectively.

28. A trap system as recited in claim 21, wherein the container assembly includes a threaded socket, and wherein the trap system further comprising a stake device having a threaded upper portion and a lower portion, the threaded upper portion being adapted to threadably connect to the threaded socket of the assembly, the lower portion of the stake device being shaped and configured for being stuck in the ground.

29. A trap system for insects comprising a container assembly defining a container chamber, wherein the container assembly comprises:
a vessel comprising a vessel side wall and a vessel end wall defining a container opening;
a cap member adapted to cover the container opening;
an obstruction member adapted to be supported by the cap member for movement between open and closed positions;
a threaded socket;
a stake device having a threaded upper portion and a lower portion, the threaded upper portion being adapted to threadably connect to the threaded socket of the assembly, the lower portion of the stake device being shaped and configured for being stuck in the ground.

30. A trap system as recited in claim 29 further comprising a hanging connector secured to an upper portion of the container assembly, the hanging connector being configured to enable a user to operatively connect the hanging connector to an elevated object, such as a post or a limb of a tree, to thereby suspend the trap system from the elevated object.

31. A trap system as recited in claim 30 wherein the hanging connector comprises a ring.
